(19) United States
(12) Patent Application Publication
(10) Pub. No.: US 2009/0161275 A1
(43) Pub. Date: Jun. 25, 2009

(54) INTEGRATED CONTROLLING CHIP

(76) Inventors: Kun-Tai Wu, Hsinchu City (TW); Chin-Chieh Chao, Hsinchu City (TW); Ching-Ching Chi, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/122,719

(22) Filed: May 18, 2008

(30) Foreign Application Priority Data
Dec. 24, 2007 (TW) 096149653

(51) Int. Cl. H02H 3/20

(52) U.S. Cl. 361/56

(57) ABSTRACT

An integrated controlling chip includes a signal processing unit, a resistance unit and an electrostatic discharge protection circuit. The signal processing unit includes an input port. The resistance unit includes a first node coupled to a signal pin of the integrated controlling chip, and includes a second node coupled to the input port of the signal processing unit. The electrostatic discharge protection circuit includes a node coupled between the first node of the resistance unit and the signal pin of the integrated controlling chip.

### BACKGROUND OF THE INVENTION

1. Field of the Invention

The present invention relates to an integrated controlling chip, and more particularly, to an integrated controlling chip having a signal processing unit, a resistance unit and an electrostatic discharge protection circuit. In addition, a first node of the resistance unit is coupled to a signal pin of the integrated controlling chip and a node of the electrostatic discharge protection circuit, and a second node of the resistance unit is coupled to an input port of the signal processing unit.

2. Description of the Prior Art

The timing controller plays one of the most important roles in a driving module for a liquid crystal display panel (LCD panel). It provides a timing controlling signal to control the source driver and gate driver operation so that the LCD panel is able to display images correctly.

During the testing process of manufacturing the timing controller, the low voltage differential signal (LVDS) input pins are often damaged due to electrical overstress (EOS). Please refer to FIG. 1. FIG. 1 is a diagram illustrating a typical timing controller 100. As shown in FIG. 1, the timing controller 100 includes LVDS input pins 112, 114, electrostatic discharge protection circuits 122, 124 and an operation amplifier 130. The electrostatic discharge protection circuits 122, 124 are made up, respectively, of an n-channel metal oxide semiconductor field effect transistor (NMOS). Please refer to FIG. 2. FIG. 2 is a curve illustrating the I-V characteristic for the LVDS input pins 112, 114 shown in FIG. 1. As shown in FIG. 2, the timing controller 100 has a threshold voltage Vth. If the value of the voltage inputted into one of the LVDS input pins 112, 114 is in excess of the threshold voltage Vth, the current value of the current flowing in the timing controller 100 is instantly increased, causing the timing controller 100 to be damaged. For example, assuming that the Vth=8 Volts, while a 10 volts input signal is inputted into the LVDS input pin 112 (114), the electrostatic discharge protection circuit 122 (124) and the operation amplifier 130 may burn out due to the overflowed current and the timing controller 100 will thereby be damaged. In other words, the threshold voltage Vth is the maximum of the EOS tolerance for the timing controller 100.

Please refer to FIG. 3. FIG. 3 is a diagram illustrating a typical timing controller 300 with current limiting resistors. The timing controller 300 includes LVDS input pins 312, 314, electrostatic discharge protection circuits 322, 324 and an operation amplifier 330. In addition, the timing controller 300 includes a first current limiting resistor 342 and a second current limiting resistor 344. The first current limiting resistor 342 is coupled between the LVDS input pin 312 and a non-inverting input of the operation amplifier 330, and the second current limiting resistor 344 is coupled between the LVDS input pin 314 and an inverting input of the operation amplifier 330. When the first and second current-limiting resistors 342, 344 are implemented into the timing controller 300, the EOS tolerance of the timing controller 300 is able to increase. However, the input signal delay time of the timing controller 300 is highly dependent on the parasitic capacitors of the electrostatic discharge protection circuits 322, 324 and the value of the parasitic capacitors are extremely large in general. Thus, adding the current-limiting resistors into the timing controller 300 results in the serious issue of delaying the input signal to the timing controller 300.

### SUMMARY OF THE INVENTION

It is therefore one of the objectives of the present invention to provide an integrated controlling chip (e.g., a timing controller) utilizing a resistance unit, one node of which is coupled to the integrated controlling chip and an electrostatic discharge protection circuit and the other node of which is coupled to a signal processing unit (e.g., an operating amplifier), in order to increase EOS tolerance without lengthening the input signal delay time.

According to an exemplary embodiment of the present invention, the integrated controlling chip comprises: a signal processing unit, which has a first input port and a second input port; a first resistance unit, which has a first node coupled to a first signal pin of the integrated controlling chip and a second node coupled to the first input port of the signal processing unit; and a first electrostatic discharge protection circuit, which has a node coupled between the first node of the first resistance unit and the first signal pin of the integrated controlling chip.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating LVDS input pins for a typical timing controller.

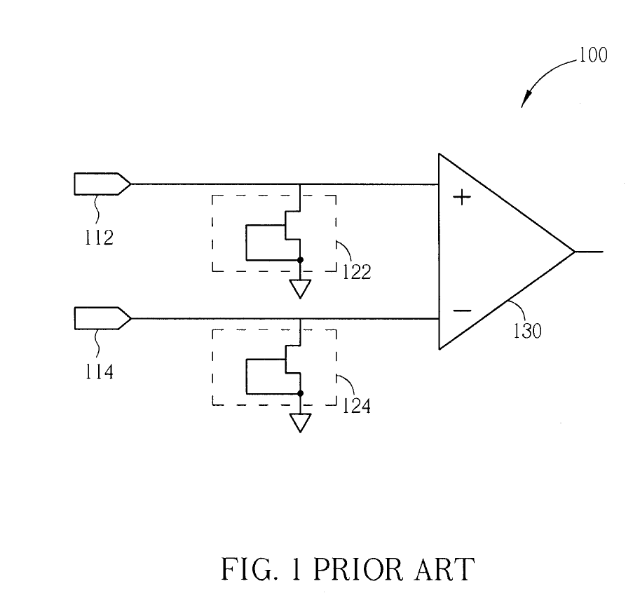

FIG. 2 is a curve illustrating the I-V characteristic for the LVDS input pins shown in FIG. 1.

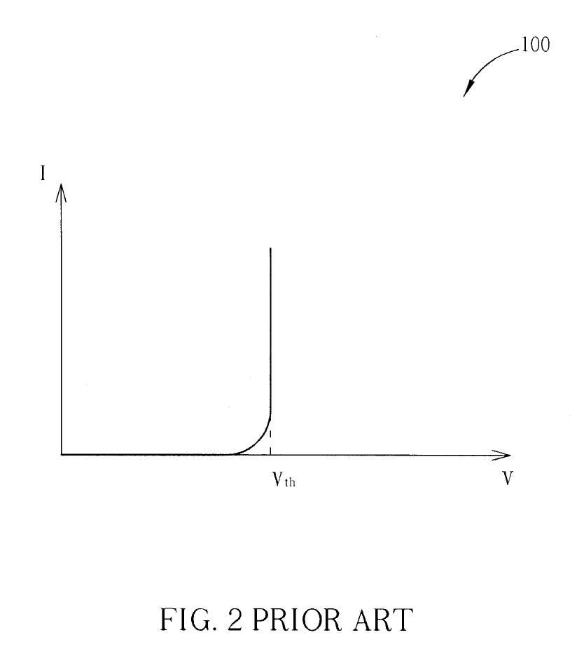

FIG. 3 is a diagram illustrating a typical timing controller with current limiting resistors.

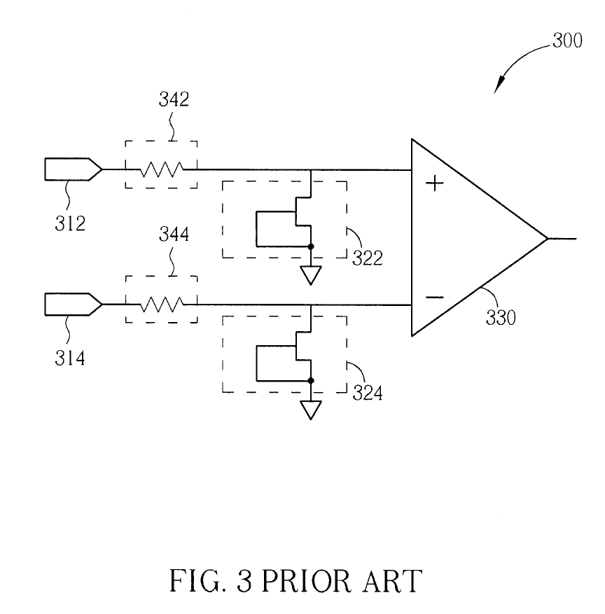

FIG. 4 is a diagram illustrating an integrated controlling chip according to an embodiment of the present invention.

### DETAILED DESCRIPTION

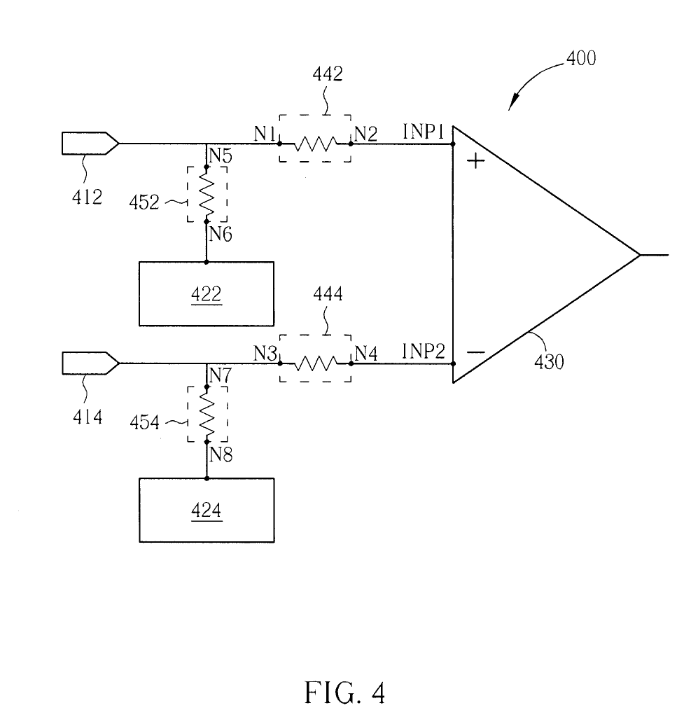

Please refer to FIG. 4. FIG. 4 is a diagram illustrating an integrated controlling chip 400 according to an embodiment of the present invention. The integrated controlling chip 400 includes a first differential signal pin 412, a second differential signal pin 414, a first electrostatic discharge protection circuit 422, a second electrostatic discharge protection circuit 424, a signal processing unit 430, a first resistance unit 442, a second resistance unit 444, a third resistance unit 452 and a fourth resistance unit 454. Please note that in this embodiment the integrated controlling chip 400 is used as a timing controller in an LCD panel, the first and second differential signal pins 412, 414 are a pair of low voltage differential signal pins, the signal processing unit 430 is an operation amplifier, and the first to fourth resistance units 442, 444, 452, 454 are all implemented by resistors; these are, however, for illustrative purposes and are not limitations of the present invention.

As shown in FIG. 4, the signal processing unit 430 (the operation amplifier) has a first input port INP1 (the non-inverting input) and a second input port INP2 (the inverting input). A first node N1 of the first resistance unit 442 is coupled to the first differential signal pin 412 of the integrated controlling chip 400, a second node N2 of the first resistance unit 442 is coupled to the first input port INP1 of the signal processing unit 430; a first node N3 of the second resistance unit 444 is coupled to the second differential signal pin 414 of the integrated controlling chip 400, a second node N4 of the second resistance unit 444 is coupled to the second input port INP2 of the signal processing unit 430; the third resistance unit 452 is connected to the first electrostatic discharge protection circuit 422, a first node N5 of the third resistance unit 452 is coupled between the first differential signal pin 412 of the integrated controlling chip 400 and the first node N1 of the first resistance unit 442, a second node N6 of the third resistance unit 452 is coupled to the first electrostatic discharge protection circuit 422; and the fourth resistance unit 454 is connected to the second electrostatic discharge protection circuit 424, a first node N7 of the fourth resistance unit 454 is coupled between the second differential signal pin 414 of the integrated controlling chip 400 and the first node N3 of the second resistance unit 444, and a second node N8 of the fourth resistance unit 454 is coupled to the second electrostatic discharge protection circuit 424. In this way, the first and second resistor units 442, 444 can increase the EOS tolerance of the signal processing unit 430, and the third and fourth resistor units 452, 454 can respectively increase the EOS tolerance of the first and second electrostatic discharge protection circuit 422, 424.

It is supposed that the resistance of the first resistance unit 442 is R1 and the capacitance of the parasitic capacitor for the first input port INP1 of the signal processing unit 430 (the non-inverting input of the operation amplifier) is Cgs1. It is supposed that the resistance of the second resistance unit 444 is R2 and the capacitance of the parasitic capacitor for the second input port INP2 of the signal processing unit 430 (the inverting input of the operation amplifier) is Cgs2. Under this circumstance, the input signal delay time for the first differential input pin 412 of the integrated controlling chip 400 is equal to R1*Cgs1, and the input signal delay time for the second differential input pin 414 of the integrated controlling chip 400 is equal to R2*Cgs2. Since the capacitance of the parasitic capacitor for the input ports of the operation amplifier (Cgs1 and Cgs2) is very small, the input signal delay time of the integrated controlling chip 400 is not affected by adding the first to fourth resistance units 442, 444, 452, 454.

As demonstrated by the above example, the input signal delay time for the integrated controlling chip 400 is not affected by the parasitic capacitors of the first and second electrostatic discharge protection circuits 422, 424. Compared with the prior art, the integrated controlling chip of the present invention can significantly increase its EOS tolerance without lengthening the input signal delay time.

Those skilled in the art will readily observe that numerous modifications and alterations of the device and method may be made while retaining the teachings of the invention.

What is claimed is:

1. An integrated controlling chip, comprising:
a signal processing unit, having a first input port and a second input port;
a first resistance unit, having a first node coupled to a first signal pin of the integrated controlling chip and a second node coupled to the first input port of the signal processing unit; and
a first electrostatic discharge protection circuit, having a node coupled between the first node of the first resistance unit and the first signal pin.

2. The integrated controlling chip of claim 1, wherein the signal processing unit is a signal amplifier.

3. The integrated controlling chip of claim 1, further comprising:
a second resistance unit, connected to the first electrostatic discharge protection circuit in series and coupled between the first resistance unit and the first electrostatic discharge protection circuit.

4. The integrated controlling chip of claim 1, further comprising:
a second resistance unit, having a first node coupled to a second signal pin of the integrated controlling chip and a second node coupled to the second input port of the signal processing unit; and
a second electrostatic discharge protection circuit, having a node coupled between the first node of the second resistance unit and the second signal pin.

5. The integrated controlling chip of claim 4, further comprising:
a third resistance unit, connected to the first electrostatic discharge protection circuit in series and coupled between the first resistance unit and the first electrostatic discharge protection circuit; and
a fourth resistance unit, connected to the second electrostatic discharge protection circuit in series and coupled between the second resistance unit and the second electrostatic discharge protection circuit.

6. The integrated controlling chip of claim 5, wherein the first, second, third and fourth resistance units are all resistors.

7. The integrated controlling chip of claim 4, wherein the first and second signal pins are a pair of low voltage differential signal (LVDS) pins.

8. The integrated controlling chip of claim 1, wherein the first resistance unit is a resistor.

9. The integrated controlling chip of claim 1, being a timing controller.

10. The integrated controlling chip of claim 9, wherein the timing controller is disposed in a liquid crystal display panel.
